(19) United States
(12) Patent Application Publication
(10) Pub. No.: US 2025/0261590 A1
(43) Pub. Date: Aug. 21, 2025

(54) Riding Lawn Mower Lawn Trimmer Attachment

(71) Applicant: Mark Beyer, Utica, OH (US)

(72) Inventor: Mark Beyer, Utica, OH (US)

(21) Appl. No.: 18/442,096

(22) Filed: Feb. 15, 2024

(51) Int. Cl. A01D 43/16; A01D 34/416; A01D 101/00

(52) U.S. Cl. CPC A01D 43/16; A01D 34/4165; A01D 34/4166; A01D 34/4167; A01D 2101/00

(57) ABSTRACT

The current invention is a Riding Lawn Mower Lawn Trimmer Attachment that can be efficiently attached to at any riding deck. It can also trim at an angle. The current invention has a trimmer which has a trimmer guard, an extender rod, and an adjustable angle bar to control the angle of the trim heads. Trim heads, trim cords, a drive system which in the preferred embodiment is a pully system attached to the mower drive pully, a support and a hinged connection to the lawn mower.

### TECHNICAL FIELD

The technology discussed below relates a Lawn Trimmer and more particularly one attaches to a riding lawn mower.

### RELATED APPLICATIONS

None.

### BACKGROUND

Many times homeowners or landscapers need to maintain their property by periodically cutting or trimming vegetation, such as grass, weeds, flowers and small plants that cannot be reached by a riding lawnmower or zero turn. There is a desire to save time by not stopping mowing, turn off the mower and get a weed trimmer. Sometimes this vegetation is an angle that is not flat so the weed trimmer would need to be placed at an angle.

There is still room for improvement in the art.

### SUMMARY

The current invention is a non-electric Riding Lawn Mower Lawn Trimmer Attachment that can be efficiently attached to at any riding deck. It can also trim at an angle. The current invention has a trimmer which has a trimmer guard, an extender rod, and an adjustable angle bar to control the angle of the trim. Trim heads, trim cords, a drive system which in the preferred embodiment is a pully system attached to the mower drive pully, a support and a hinged connection to the lawn mower.

These are improvements over the current art.

### DRAWINGS

FIG. 1 shows the system attached to a lawn mower;

FIG. 2 shows under the trimmer guard;

FIG. 3 displays another view of under the trimmer guard;

FIG. 4 shows the support and its hinged connection to the lawn mower;

FIG. 5 shows the trimmer in the non-use position;

FIG. 6 shows the extender rod;

FIG. 7 show the trimmer in the position for usage;

FIG. 8 shows a front view of the trimer;

FIG. 9 shows a top view of the trimmer;

FIG. 10 shows the pulley driving system;

FIG. 11 shows the support from a side view;

FIG. 12 shows the adjustable height bracket;

FIG. 13 shows the trim card angle adjuster;

FIG. 14 shows another view of the pully system;

FIG. 15 shows the components of the pully system including the coupler; and

FIG. 16 shows the guard and bolt; and

FIG. 17 shows a crosscut of the extender.

### MAIN COMPONENTS

1 Device
10 Trimmer Safety Guard
15 Auto Deflector
17 Release Mechanism
20 Extender
25 Extender nut
30 trim string
35 trim string holder
40 angle bar
45 angle adjuster
50 driver system
55 drive shaft coupler
56 drive shaft washer
60 trimmer cross guard support
61 trimmer bar
62 upper trimmer support bracket
65 belt adjuster
66 bracket height adjuster
67 lower trimmer support bracket
70 trimmer belt guide pully
75 trimmer driver pully
77 belt guard
80 support hinge
81 support hinge bolt
88 trimmer cable
90 driver belt
95 belt guide
100 lawn mower
110 lawn mower pully system
115 lawn mower drive belt
120 lawn mower pully
130 return spring
160 cross bracket
210 Drive Shaft bolt
500 Guard
510 Spring Bolt

### DETAILED DESCRIPTION

The illustrations presented herein are, in some instances, not actual views of any particular framing devices or components thereof but may be idealized representations which are employed to describe the present disclosure. Additionally, elements common between figures may retain the same numerical designation.

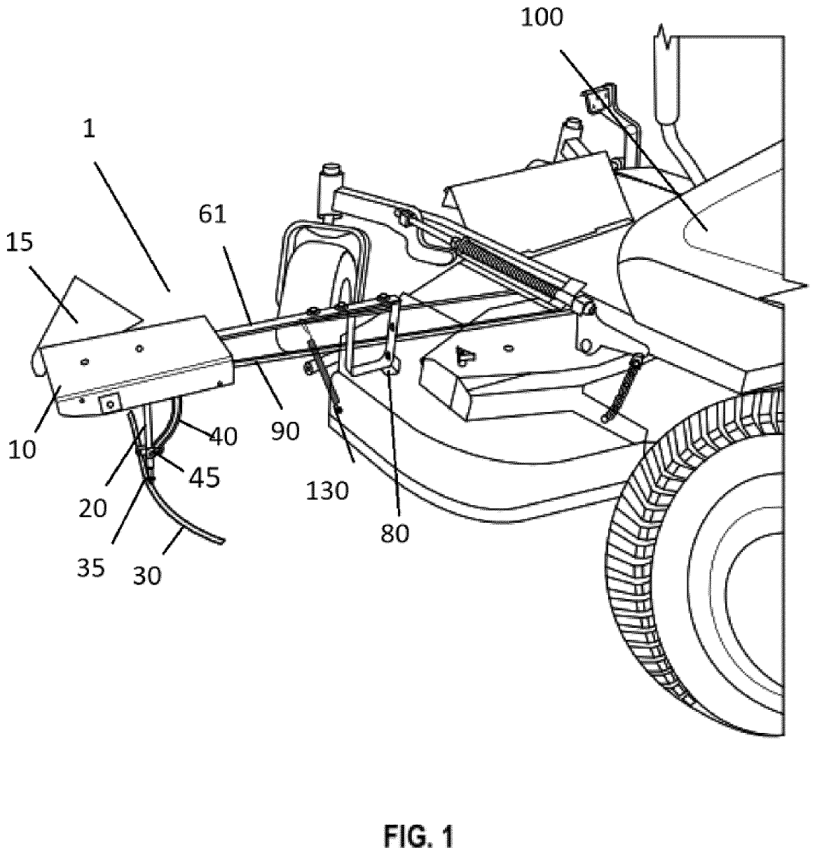

The current invention is a lawn trimmer attachment for a riding lawn mower as shown in FIGS. 1 through 17.

FIGS. 1 through 17 show a Riding Lawn Mower Lawn Trimmer 1 that can be efficiently attached to at any riding deck or can come with the riding deck. It can also trim at an angle. The current invention has a trimmer 1 which has a Trimmer Safety Guard 10, an Auto Deflector 15, an extender 20, an adjustable angle bar 40 to control the angle of the trim string holder 35, trim string 30, a drive system which in the preferred embodiment is a pully system attached to the trimmer belt guide pully 70, a support and a support hinge 80 connection to the lawn mower 100.

The lawn mower trimmer 1 can be built into an existing lawn mower 100 or be part of a kit to attached to an existing lawn mower 100.

FIG. 1 shows the frame of the trimmer attachment 1 being connected to the lawn mower 100. This connection can be permanent or temporary. The trimmer 1 is connected to the lawn mower 100 through a trimmer bar 61 that is attached to the mower deck with a support hinge 80. The trimmer bar 61 extends straight out from the lawn mower 100 in the preferred embodiment. At the end of trimmer bar 61 is a Trimmer Safety Guard 10 which covers the trimming head with its components to protect the users. At the front of the trimmer safety guard 10 is an Auto Deflector 15. The Auto Deflector 15 is angled away from the trimmer 1 and the lawn mower 100 so that if the trimmer 1 hits an obstacle the trimmer head is moved away from the obstacle at an angle. The trimmer 1 has a return spring 130 that uses tension to hold the trimmer bar 61 in place with a downward pressure downward making sure that trimmer bar 61 is held in place.

FIG. 1 also shows the Extender 20 extending down from the trimmer head. The angle bar 40 attaches to the extender 20 by the angle adjuster 45. The angle bar 40 allows the user to change the angle of the trim sting holder 35 holding the trim string 30 to change the angle of the trim.

FIG. 1 also shows a view of part of the driver system 50 having a driver belt 90.

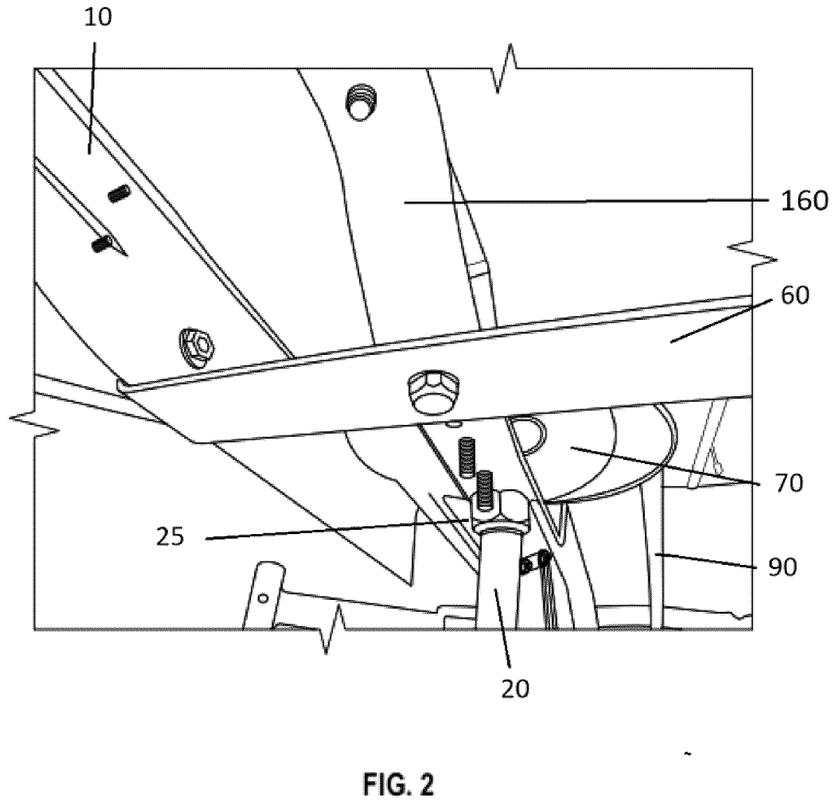

FIG. 2 shows under the trimmer safety guard 10. The trimmer cross guard support 60 connects to the sides of the trimmer safety guard 10 as well to a cross bracket 160. The extender 20 is connected to and extends out from the cross bracket 160. FIG. 2 also shows the trimmer belt guide pully 70 which is part of the pully system 50 and is turned by the driver belt 90.

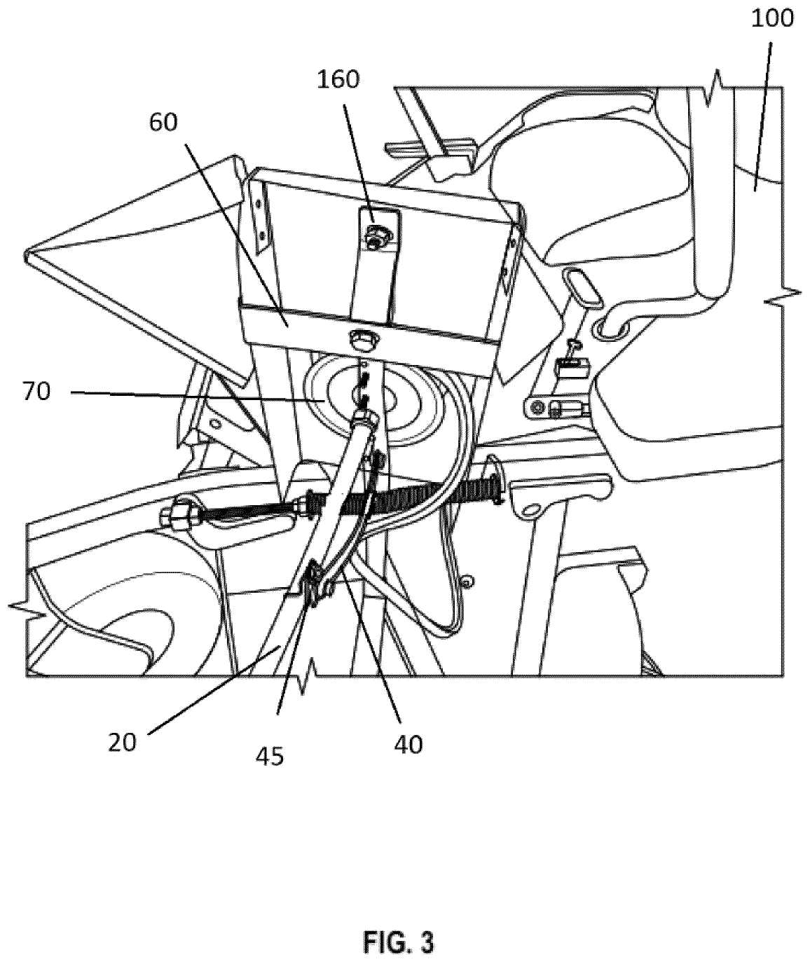

FIG. 3 displays another bottom view of under the trimmer guard 10 with a view of the angle bar 40 being connect to the extender 20 by angle adjuster 45. FIG. 3 shows a cross bracket 160 being connected to the trimmer safety guard 10.

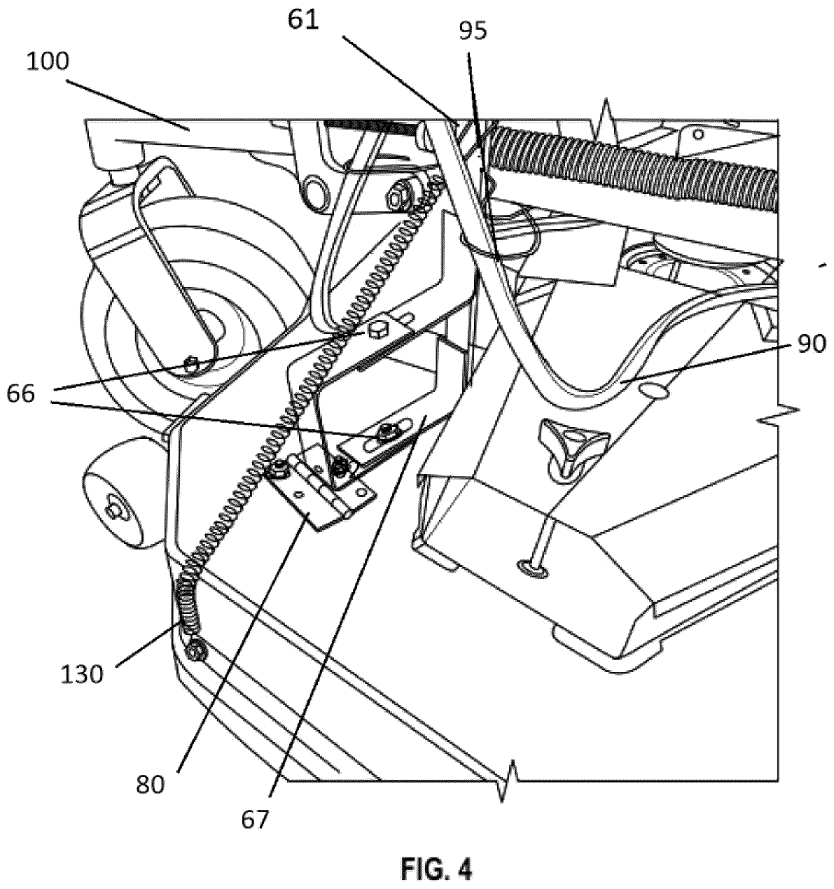

FIG. 4 shows the support and its hinged connection of the trimmer 1 to the lawn mower 100 with the trimmer 1 in an up-storage position with the trimmer bar 61 connected to one or more of upper trimmer support brackets 62 and lower which connects to trimmer support brackets 67. This connection has bracket height adjusters 66 that consist of a screw and a slot allowing the user to adjust the height of the trimmer bar 61 and therefore the height of trim sting holder 35 holding the trim string 30 allowing the user to control the height of the trim. The lower trimmer support brackets 67 are connected to the mower deck with a support hinge 80 which is connect to the lawn mower, normally to the deck. In FIG. 4, the return spring 130 is extended. FIG. 4 shows the belt guide 95 which encircles the driver belt 90 to make sure that it is held in place. It can be made from metal or similar material like hard plastic or plastic band. The brackets and bars are made from a sturdy material such as metal.

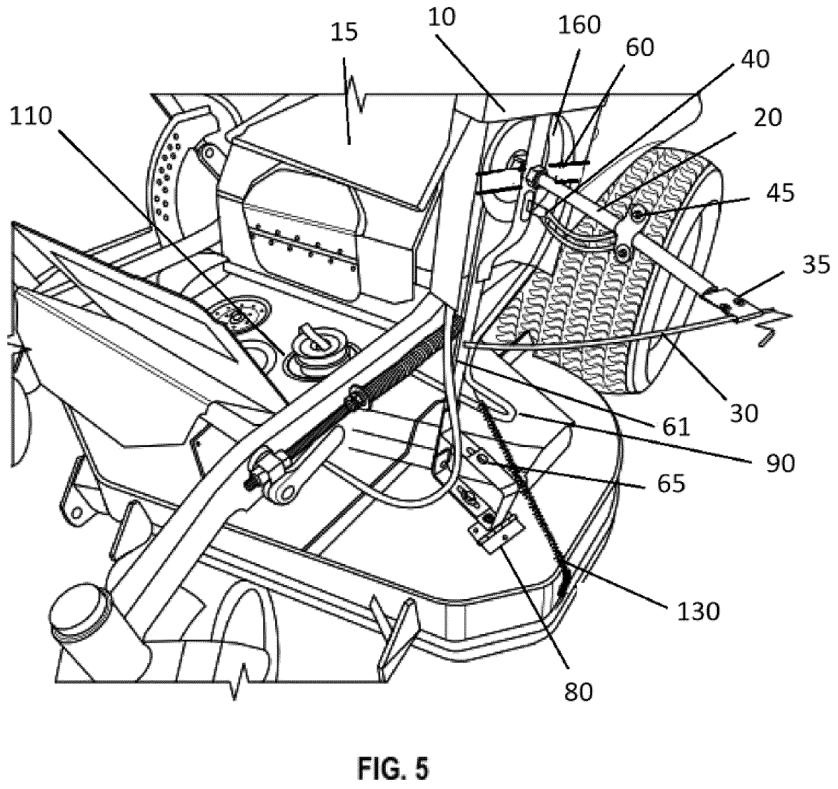

Like FIG. 4, FIG. 5 shows the trimmer 1 in the non-use position where the belt with the lawn mower pully system 110.

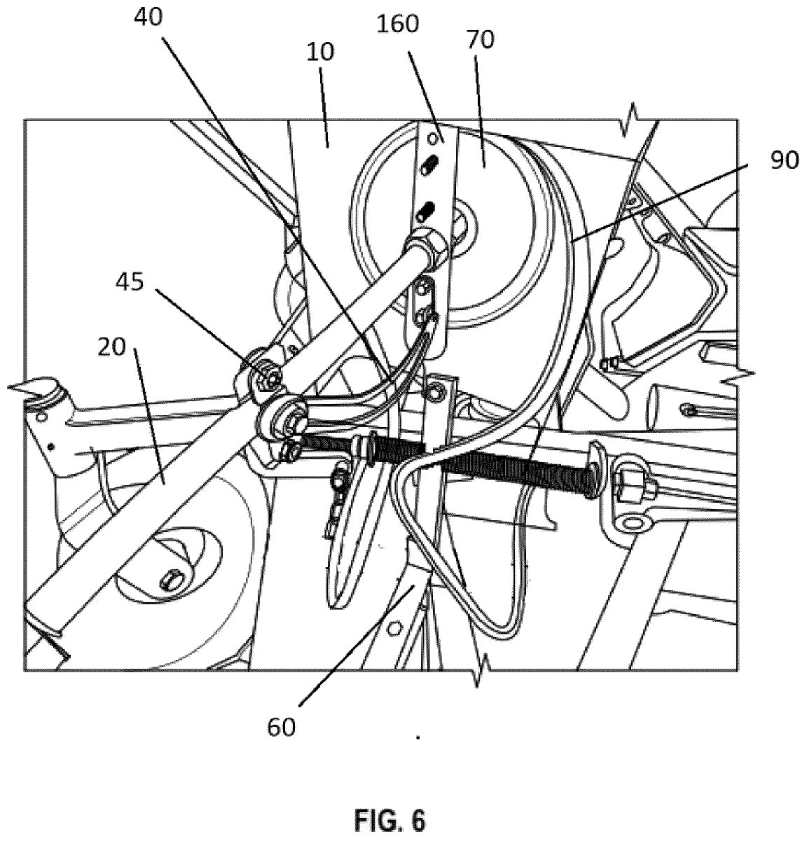

FIG. 6 shows extender rod 20 connected to the angle bar 40 by angle adjuster 45 where the angle adjuster is a nut and bolt system which fits into an open angled area in the angle bar 40 where it is loosened to adjust and tighten to lock the extender rod 20 into place. In the preferred embodiment the angle bar 40 top is connected to the cross bracket 160.

The extender rod 20 is a hollow tube made of a flexible strong material. The trim string 30 runs through the extender rod 20 to the trim string holder 35.

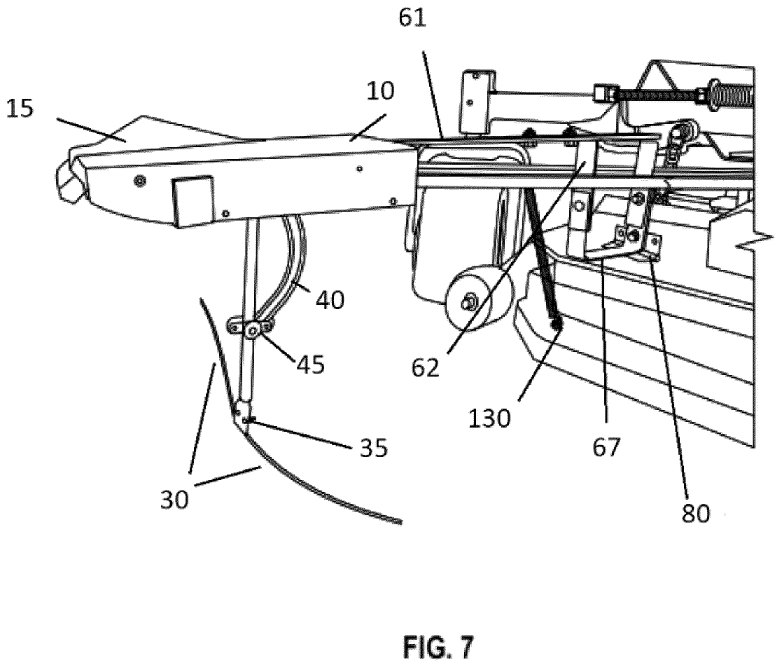

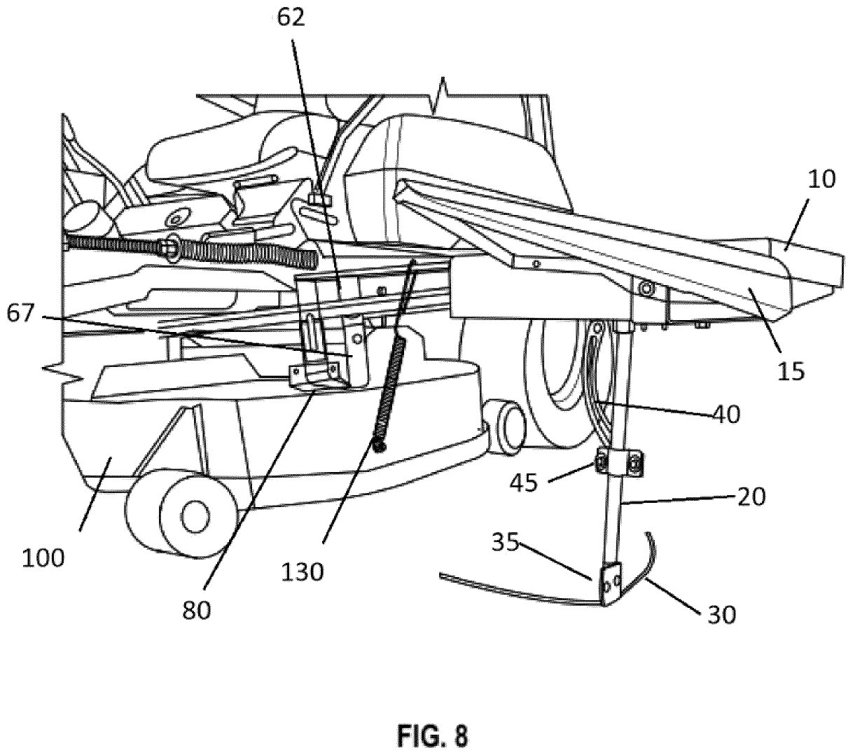

FIG. 7 is a view of the trimmer 1 from the rear in the position for usage while FIG. 8 shows a front view. FIG. 8 shows the trim strip holder 35 at the end of the Extender 20. The strip holder 35 holds one or more lines of trim string 30. When the extender 20 turns it turns the trim string holder 35 which spins the trim string 30. The turning trim string 30 it trims the grass or weeds that needed to be trimmed. The trim string 30 extends perpendicular from the extender 20.

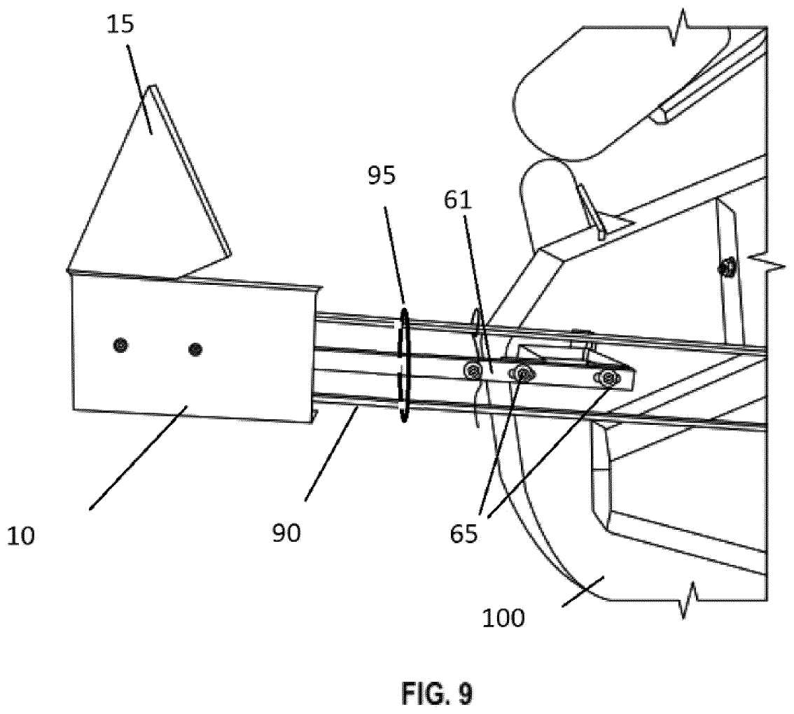

FIG. 9 shows a top view of the trimmer 1 attached to the lawn mower 100. The belt adjusters 65 allow the adjustment of the trimmer bar 61 back and forth from the lawn mower 100 allowing the user to control the tension or to remove the driver belt 90. The belt adjusters in the preferred embodiment consist of a nut and bolt and slot system where the nut is tighten to lock the length in place and loosen to adjust it or to remove the driver belt 90.

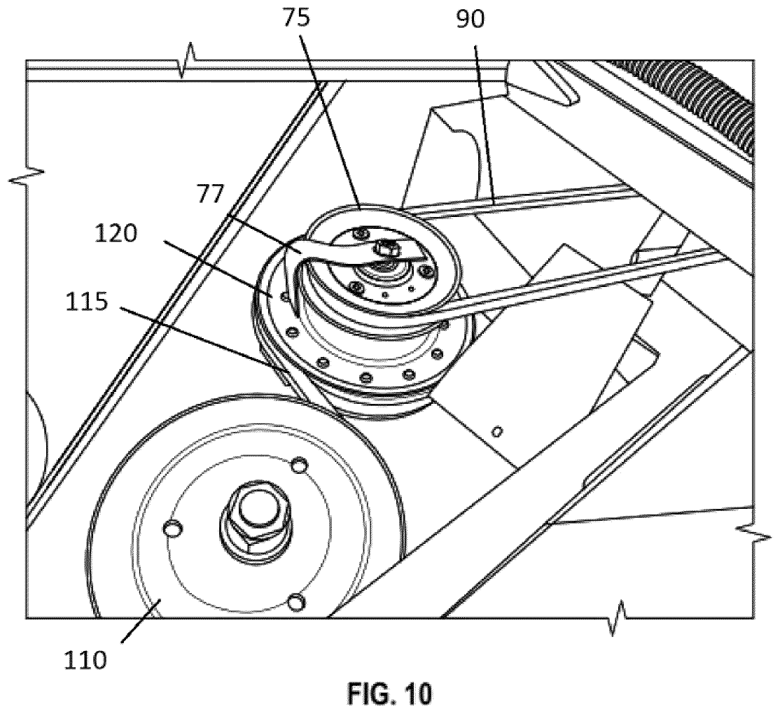

FIG. 10 shows the lawn mower's pulley driving system. The trimmer driver pully 70 is attached to the lawn mower pully so that when the lawn mower pully 120 turns driven by the lawn mower drive belt 115 it will turn the trimmer driver pully 75. A trimmer belt guide pully 77 is attached to the lawn mower 100 to make sure that the driver belt 90 stays on the trimmer driver pully 75.

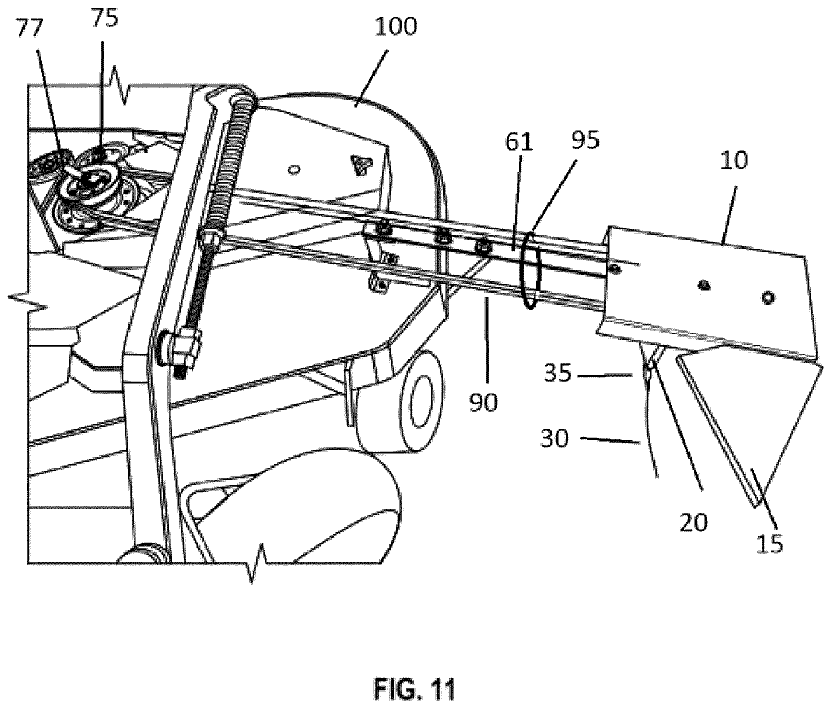

FIG. 11 shows the support and the pully driving system from a side view. It shows where the driver belt 90 loops around trimmer driver pully 75 and runs to the trimmer belt guide pully 70.

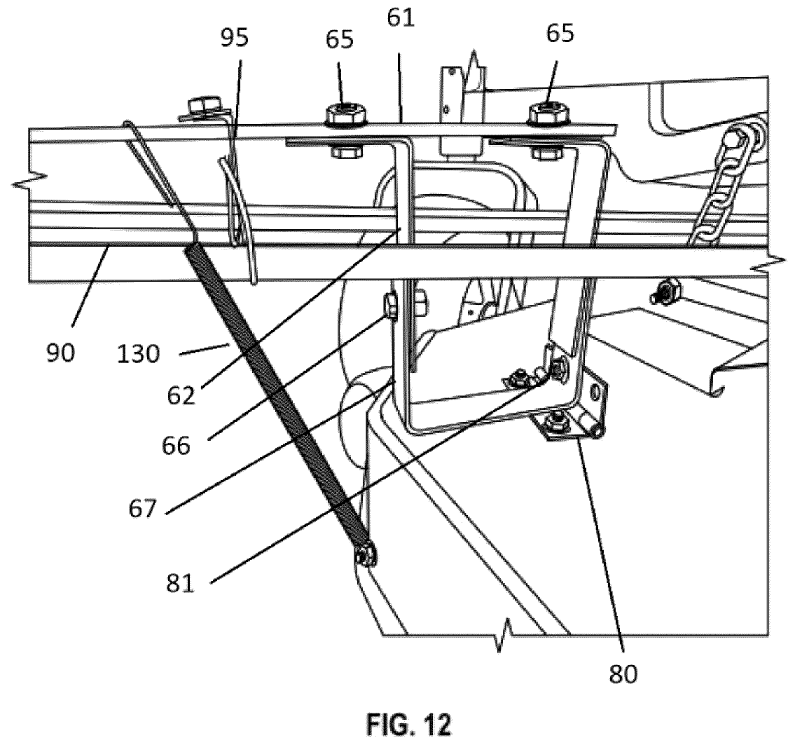

FIG. 12 shows a side view of the brackets attaching the trimmer 1 to the lawn mower 100. In the preferred embodiment a support hinge bolt 81 secures the lower trimmer support brackets 67 to the mower deck with a support hinge 80.

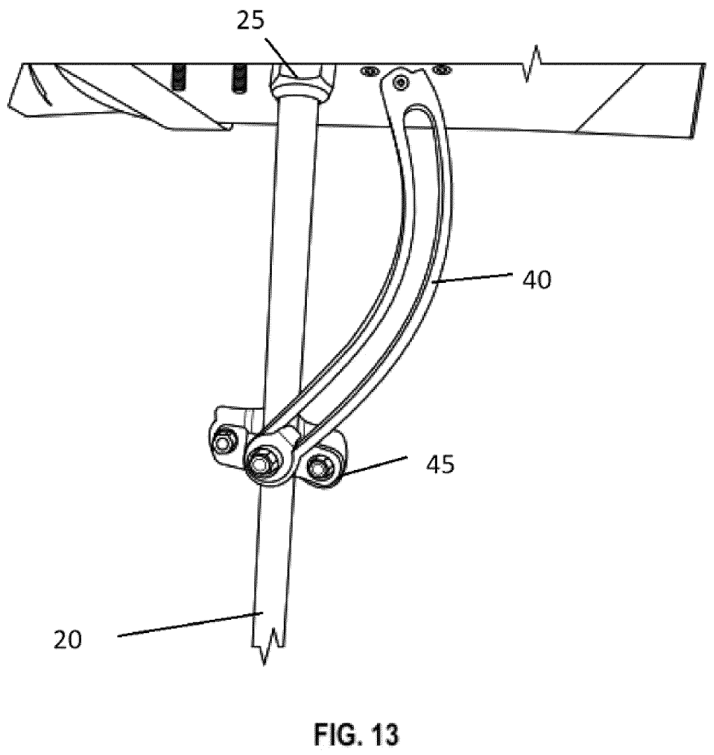

FIG. 13 a close-up view of the extender rod 20 connected to the angle bar 40 by angle adjuster 45 where the angle adjuster is a nut and bolt system which fits into an open angled area in the angle bar 40 where it is loosened to adjust and tighten to lock the extender rod 20 into place. The Extender nut 25 holds the extender rod 20 on to the cross bracket 160.

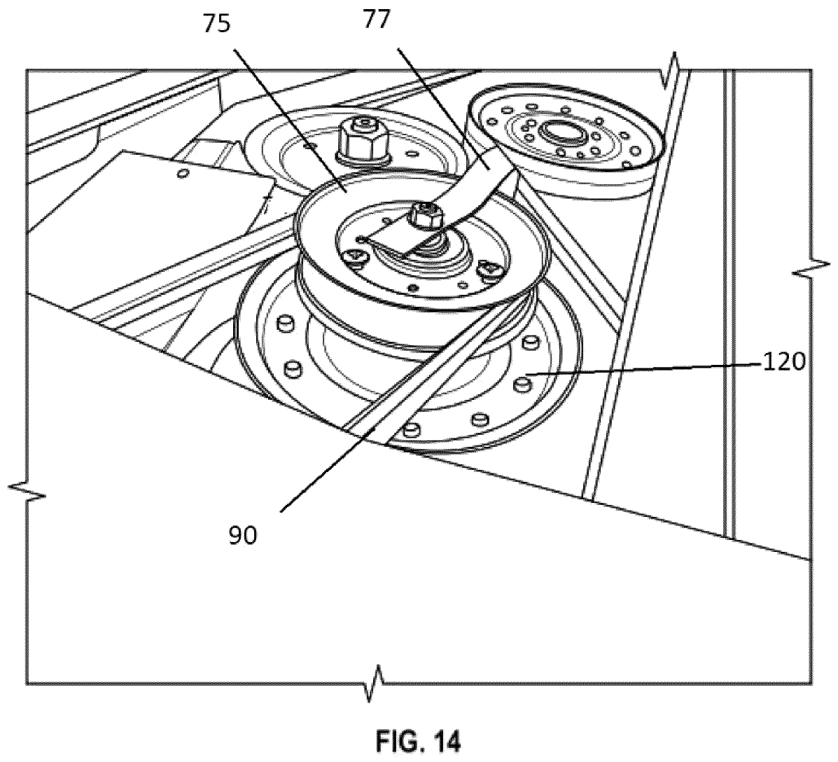

FIG. 14 shows a close up view the attachment of the pully system to the lawn mower pully system.

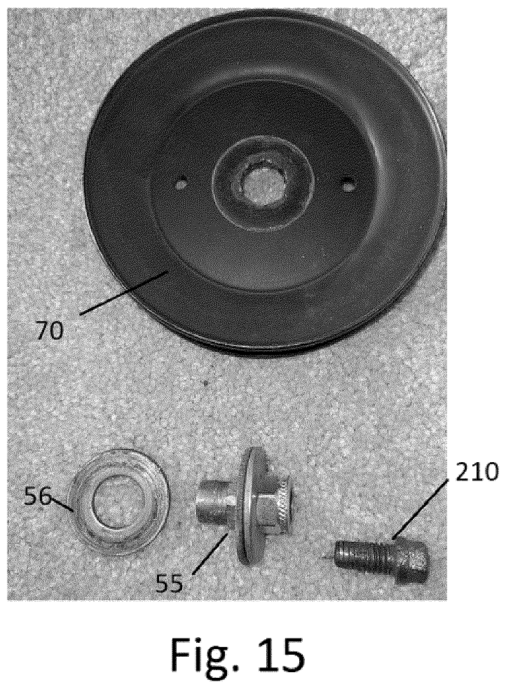

FIG. 15 shows the components of the pully system, showing an expanded view of the trimmer belt guide pully 70 which is a circular pulley with the Drive Shaft bolt 210, the drive shaft coupler 55 and the drive shaft washer 56. The trimmer belt guide pully 70 has the drive shaft coupler 55 on the inside of the trimmer belt guide pully 70 and the drive shaft washer 56 is with the drive shaft bolt 210 turned into the drive shaft coupler 55.

The cutting assembly consists of an upper driveshaft bolt (210) that screws into the drive shaft bar (61), inserts into the trimmer belt guide pulley (70) and into the proprietary drive shaft coupler (55). Driven by friction of the driver belt 90, the belt guide pulley (70) turns the drive shaft coupler (55) that holds the trimmer cable (88) inside the extender (20).

In the preferred embodiment, the drive shaft coupler (55) is made with a threaded outside so that two hex nuts can hold the coupler assembly to the trimmer cross-guard support (60) and the belt guide pulley (70) at the same time.

Inside the drive shaft coupler (55) is solid metallic-filled in most of the way with a square opening so that a cable with a square end can fit snuggly.

At the top of the drive shaft coupler (55) is enough hollowed-out space to let the upper drive shaft bolt (210) slip into and allow for movement.

The Extender (20) and the cable (88) are flexible to allow an angle bar (40) to achieve various angles to the trimming for angle areas and to cut down on multiple trimming times around objects.

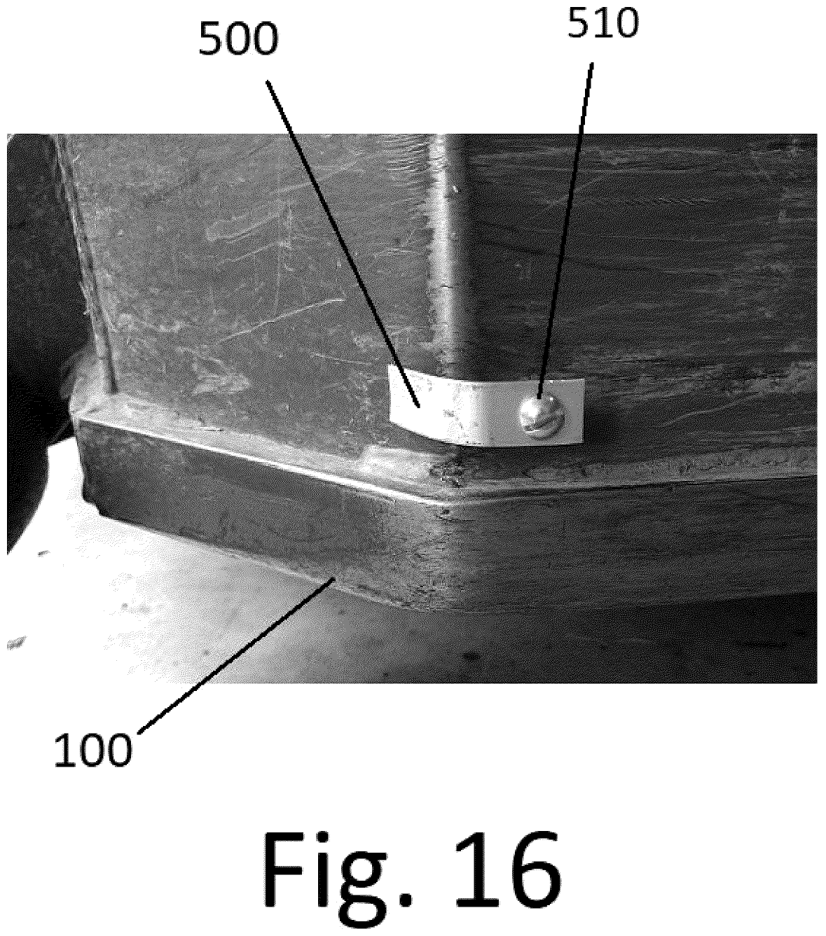

FIG. 16 shows the guard on side of the lawn mower deck which protects the deck if case objects are hit while trimming.

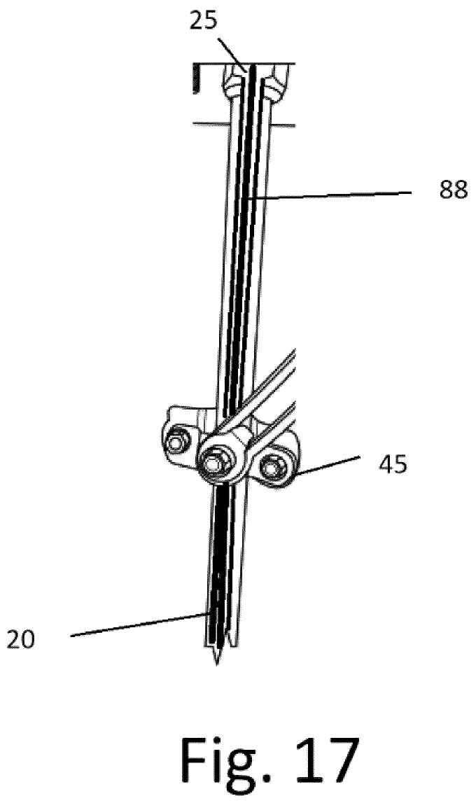

FIG. 17 shows a crosscut view of the extender 30 which shows that the extender 30 is a hollow tube which the trimmer cable 88 runs through to the trim string holder 35.

The various features associated with the examples described herein and shown in the accompanying drawings can be implemented in different examples and implementations without departing from the scope of the present disclosure. Therefore, although certain specific constructions and arrangements have been described and shown in the accompanying drawings, such embodiments are merely illustrative and not restrictive of the scope of the disclosure, since various other additions and modifications to, and deletions from, the described embodiments will be apparent to one of ordinary skill in the art.

What is claimed is:

1. A Riding Lawn Mower Lawn Trimmer comprising:
a trimmer bar with a Trimmer Safety Guard, an extender that extends out from the trimmer bar with an adjustable angle bar that controls the angle of a trim string holder, trim string, where the trimmer bar is attached to a support and a support hinge that is connected to the lawn mower and having a drive system.

2. The Riding Lawn Mower Lawn Trimmer according to claim 1 further comprising:
where the drive system is a pully system.

3. The Riding Lawn Mower Lawn Trimmer according to claim 2 further comprising:
where the drive system has a driver belt attached to a lawn mower pully that turns a lawn mower drive belt turning a trimmer driver pully which turns a trimmer cable turning trimmer cable turning the trim string holder.

4. The Riding Lawn Mower Lawn Trimmer according to claim 3 further comprising:
having a trimmer belt guide pully attached to the lawn mower securing the driver belt to a trimmer driver pully.

5. The Riding Lawn Mower Lawn Trimmer according to claim 1 further comprising:
having the extender hollow with a trimmer cable within the hollow which is attached to the trim string holder.

6. The Riding Lawn Mower Lawn Trimmer according to claim 1 further comprising:
having a trimmer cross guard support the connects to the sides of the trimmer safety guard.

7. The Riding Lawn Mower Lawn Trimmer according to claim 1 further comprising: having a cross bracket attached to the trimmer bar.

8. The Riding Lawn Mower Lawn Trimmer according to claim 1 further comprising: having the trimmer bar connected to a plurality of upper trimmer support brackets which connects to a plurality of trimmer support brackets.

9. The Riding Lawn Mower Lawn Trimmer according to claim 8 further comprising: having bracket height adjusters.

10. The Riding Lawn Mower Lawn Trimmer according to claim 9 further comprising: having the bracket height adjusters consist of a screw and a slot allowing the user to adjust the height of the trimmer bar 61 and therefore the height of trim sting holder 35 holding the trim string 30 allowing the user to control the height of the trim.

11. The Riding Lawn Mower Lawn Trimmer according to claim 8 further comprising: where the lower trimmer support brackets are connected to the mower by the support hinge.

12. The Riding Lawn Mower Lawn Trimmer according to claim 1 further comprising: where the support hinge connects a deck of the lawn mower.

13. The Riding Lawn Mower Lawn Trimmer according to claim 1 further comprising: where the angle adjuster is a nut and bolt system which fits into an open angled area in the angle bar.

14. The Riding Lawn Mower Lawn Trimmer according to claim 7 further comprising: where the angle bar has a top that is connected to the cross bracket.

15. The Riding Lawn Mower Lawn Trimmer according to claim 4 further comprising; having a cutting assembly with an upper driveshaft bolt that screws into a drive shaft bar that inserts into the trimmer belt guide pulley and into a drive shaft coupler.

16. The Riding Lawn Mower Lawn Trimmer according to claim 15 further comprising; the belt guide pulley turns the drive shaft coupler that holds the trimmer cable inside the extender.

17. The Riding Lawn Mower Lawn Trimmer according to claim 1 further comprising: where the angle adjuster is a nut and bolt system which fits into an open angled area in the angle bar.

18. A Riding Lawn Mower Lawn Trimmer comprising:
a trimmer bar with a Trimmer Safety Guard, an extender that extends out from the trimmer bar with an adjustable angle bar that controls the angle of a trim string holder, trim string, where the trimmer bar is attached to a support and a support hinge that is connected to the lawn mower and having a drive system where the drive system has a driver belt attached to a lawn mower pully that turns a lawn mower drive belt turning a trimmer driver pully which turns a trimmer cable turning trimmer cable turning the trim string holder and having the extender hollow with a trimmer cable within the hollow which is attached to the trim string holder.

19. The Riding Lawn Mower Lawn Trimmer according to claim 18 further comprising; having a cutting assembly with an upper driveshaft bolt that screws into a drive shaft bar that inserts into the trimmer belt guide pulley and into a drive shaft coupler.

20. The Riding Lawn Mower Lawn Trimmer according to claim 18 further comprising; being a kit.
